(19) United States
(12) Patent Application Publication
(10) Pub. No.: US 2005/0059554 A1
(43) Pub. Date: Mar. 17, 2005

(54) Parting agents for metal-clad high-temperature superconductor wires and tapes

(76) Inventors: Nicholas Joseph Long, Wellington (NZ); Nicholas Strickland, Lower-Hutt (NZ)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/489,015

(22) PCT Filed: Sep. 10, 2002
(86) PCT No.: PCT/NZ02/00174

(30) Foreign Application Priority Data
Sep. 10, 2001 (NZ) 514068

(51) Int. Cl. H01B 1/00

(52) U.S. Cl. 505/100

(57) ABSTRACT

A method of processing an oxide superconductor or a precursor thereto contained within an outer cladding or a matrix of an inert metal to form a metal-clad HTS conductor or precursor conductor, includes applying a formulation to the exterior of the conductor including a diffusion bond-inhibiting agent comprising predominantly calcium sulphate, potassium sulphate, sodium sulphate, lithium sulphate, or a combination thereof, typically evaporating the carrier where a liquid carrier is used, to leave a coating of the diffusion bond-inhibiting agent on the exterior of the metal-clad HTS conductor, and shaping the coated conductor so that portions thereof come into contact with one another, by coiling or spooling the conductor for example, and heat treating the conductor. The diffusion bond-inhibiting coating prevents bonding together of the conductor coils or layers during the heat treatment.

### FIELD OF THE INVENTION

The invention relates to a method of processing an oxide superconductor contained within a metal cladding or matrix to form a conductor wire or tape or similar, by applying a division bond-inhibiting agent to the conductor which minimises bonding together of the conductor when coiled during heat processing of the conductor example.

### BACKGROUND

Superconductors are known to have application in magnets, cables, motors, generators, transformers and other related devices and technologies. Once cooled below their critical temperature, T_{c}, superconductors lose their resistance to DC electrical current and hence conduct electricity efficiently and may carry a very high electrical current density. These remarkable properties motivate the aforementioned commercial and scientific applications. Examples of such superconductors which have been used in such applications include niobium tin and niobium titanium. These have low T_{c} values and are generally referred to as low temperature superconductors (LTS). The discovery of HTS materials based on cuprate oxides with T_{c} values exceeding the boiling point of liquid nitrogen (77K) raised the prospect of wider scale application because of their potential use at more easily accessible temperatures.

The common method for preparing long-length HTS wires is the so-called powder-in-tube method whereby precursor powders are packed into a metal tube, usually silver, which is then drawn down in size, then several of these drawn wires may be bundled together in another metal tube, usually silver, which is then subjected to a series of rolling and heat treatment steps. This results in a thin HTS tape with multiple filaments. The drawn wire may be rebundled more than once to achieve higher numbers of filaments. Typically, the heat treatment must be carried out under tight constraints of temperature and temperature gradient, in general under different oxygen partial pressure at different stages of the heat treatment and the annealing may continue for several days. For long superconducting tapes of length 100 m or even several km, it is thus generally impractical for a continuous feed of tape through a furnace and some form of batch processing must be utilised. Efficient batch thermal processing of long superconducting tapes requires that the tape be coiled onto a spool, in order to maximize the quantity of tape that can be processed in a furnace. At the processing temperatures, which may exceed 800° C., the silver tends to soften and adjacent layers of tape tend to stick or bind together.

U.S. Pat. No. 5,140,006 discloses a method and apparatus for coating a silver-clad oxide superconductor wire with a diffusion bond-inhibiting material and taking up the coated wire on to the spool. Rare earth oxides are specifically disclosed as a desirable diffusion bond-inhibiting material.

U.S. Pat. No. 5,952,270 and U.S. Pat. No. 6,365,554 (the latter published after the priority date of the subject application) disclose applying to an HTS wire a mixture comprising an isolating material and a porosity-inducing component. The isolating material is preferably aluminium, calcium, tantalum, magnesium, zirconium or tungsten oxide. The porosity-inducing component can be cellulose, wood dust, a graphite paraffin, polypropylene or polyethylene. During heat treatment the porosity-inducing component combusts or decomposes leaving pores in the isolating layer consisting of the residual or isolating material, so that it is then easier to remove the isolating material layer by abrasion, chemical etching or similar. The use of oxide powders applied to the tape surface as a parting agent has a number of disadvantages, including a tendency for the particles to bed down in the surface of the silver at high temperatures and thus requiring subsequent scraping and possibly an acid etch for complete removal. Mechanical scraping is undesirable and an acid etch can attack any pin-holes or weep holes where the HTS oxide may be accessible from the surface thus causing deterioration of the superconducting properties of the HTS tape.

The optimum requirements for a suitable parting agent for HTS tapes, especially those incorporating silver as the cladding metal, are exact. The parting agent should, amongst other requirements:
1. be easily applied to the surface of the HTS tape in a manner suitable for in-line manufacturing;
2. survive the thermal cycling without melting, sintering or sticking to the cladding metal;
3. facilitate easy parting of silver tape layers even when applied as a thin (20-50 μm) layer;
4. be chemically and mechanically compatible (preferably inert) with the HTS tape cladding metal, the HTS oxide material, and the precursor oxide materials;
5. be easily and completely removed after processing, preferably by dissolution in a non-aggressive solvent;
6. preferably not degrade the superconducting properties of the HTS tape;
7. preferably be inexpensive or recyclable.

### SUMMARY OF INVENTION

It is an object of the invention to go at least some way towards meeting all or at least some of the foregoing optimum requirements.

In broad terms in one aspect the invention comprises a method of processing an oxide superconductor or a precursor thereto contained within an outer cladding or a matrix of an inert metal to form a metal-clad HTS conductor or precursor conductor, including:
applying to the exterior of the conductor a coating comprising a diffusion bond-inhibiting agent comprising predominantly calcium sulphate, potassium sulphate, sodium sulphate, lithium sulphate, or a combination thereof; and
shaping the coated conductor so that portions thereof come into contact with one another and heat treating the conductor.

Preferably the diffusion bond-inhibiting agent comprises predominantly sodium sulphate or potassium sulphate or a combination thereof.

Preferably the method includes the subsequent step of removing at least part of the diffusion bond-inhibiting agent from the exterior of the conductor with an aqueous solvent.

In a further aspect the invention comprises a method of processing an oxide superconductor or a precursor thereto contained within outer cladding or a matrix of an inert metal to form a metal-clad HTS conductor or precursor conductor, including:
applying a diffusion bond-inhibiting agent selected from calcium sulphate, potassium sulphate, sodium sulphate, lithium sulphate, or a combination thereof, to the exterior of the conductor,
winding the coated conductor on to a spool,
heat processing the coiled coated conductor, and
unwinding the conductor and washing the conductor with an aqueous solvent to remove the diffusion bond-inhibiting agent from the exterior of the conductor.

In a further aspect the invention comprises an HTS conductor or precursor conductor comprising an oxide superconductor or a precursor thereto contained within an outer cladding or a matrix of an inert metal and having an amount of a coating on at least a part of the exterior of the conductor comprising predominantly calcium sulphate, potassium sulphate, sodium sulphate, or lithium sulphate, or a combination thereof, which is effective to enable winding heat processing, and winding of the conductor substantially without diffusion-bonding together of wound coils of the conductor during the heat processing.

### BRIEF DESCRIPTION OF THE FIGURES

The accompanying figures are referred to in the following disclosure. In the figures:

FIG. 1 shows SEM images of the sample surfaces of silver-clad Bi-2223 tapes after being processed with the indicated parting agents, then soaked in hot water. The images are for the parting agents CaSO₄, K₂SO₄, Na₂SO₄ and for an uncoated tape after the same heat treatment.

FIG. 2 shows a SEM micrographs of a Na₂SO₄ layer on the surface of a silver-clad HTS tape (a) before, and (b) after annealing at ≈830° C. in air for 16 hours.

FIG. 3 shows critical current, I_{c}, of four tapes displayed as the current dependence of voltage in a four-terminal measurement. The voltage is normalised by the length spacing between the voltage electrodes. (a) uncoated tape, I_{c}=37.2 A, (b) coated tape, I_{c}=40.1 A, (c) coated on both sides of tape, I_{c}=40.2 A, (d) fourth piece out of a stack of seven coated tapes, I_{c}=38.3 A.

FIG. 4 shows a sequence of SEM micrographs of layers of Na₂SO4 parting agent on the surface of a silver-clad Bi 2223 tape with increasing layer thickness from panels 1 to 3, showing, (a) cross-sectional views, and (b) surface views.

FIG. 5 shows a surface SEM image of a tape that was etched to expose Bi-2223 filaments. The left hand side shows evidence of reaction of the oxide with Na₂SO₄ during heat treatment.

FIG. 6 shows cross section SEM images of the same sample as shown in FIG. 5 depicting regions (a) affected and (b) unaffected by reaction with the Na₂SO₄ parting agent during heat treatment. The Na₂SO₄ has been removed by dipping in water.

FIG. 7 shows a side-on cross-sectional image of a section of silver-clad Bi-2223 HTS tape coated with Na₂SO₄, in which a small section of the silver surface has been etched away (top left) prior to coating and heat treatment. The exposed filament has been affected no more than 1 mm beyond the point of exposure.

### DETAILED DESIGN OF THE INVENTION

Typically in carrying out the method of the invention a metal clad high temperature superconducting (HTS) wire or tape is coated with a diffusion bond-inhibiting or parting agent then looped, spooled or otherwise coiled together prior to heat treatment; such heat treatment being necessary to react and sinter the HTS material contained in the wire, so that the parting agent prevents the wire or tape layers from sticking, binding or sintering (diffusion bonding) together during heat treatment thus allowing the loops of the coil to be subsequently parted or otherwise separated. The parting agents comprise the sulphates of lithium, sodium, potassium or calcium, or any combination thereof, which may be sprayed, dip-coated, painted or otherwise coated onto the outer surfaces of the wire or tape. Preferably the coating will be applied as a spray thus providing a more uniform coating with reduced tendancy to bead up due to the surface tension of water. If large droplets form on the surface then evaporation is slow and the resultant coating is non-uniform in its coverage. Following heat treatment of the wire or tape and subsequent cooling, the parting agents may be removed from the cladding metal by dissolution in water or other suitable non-aggressive solvent.

The parting agent is applied to one or more external surfaces of the metal-clad HTS conductor or precursor conductor which is typically in the form of wire or tape, referred to hereafter as “HTS tape”. By “precursor conductor” is meant a cladding or matrix of inert metal containing precursor material typically metal oxide powders or an intermediate HTS, which has not yet been heat processed to react the material to the final HTS. The parting agent is inert with respect to the metal cladding or matrix and is sufficiently inert with respect to the HTS oxide material which may be exposed to the parting agent during heat treatment through pin-holes, weep-holes or other such-like defects. Normal processing of the HTS tape may be used in combination with the parting agent, with no particular modification of the heat treatment or associated gaseous atmosphere necessarily being required when the parting agent is used. The parting agent is subsequently easily removed after the heat treatment by dissolution after the heat treatment of said HTS tape.

Typically the diffusion bond-inhibiting agent or parting agent will be applied to the conductor in an aqueous carrier (and it is one of the benefits of at least a preferred embodiment of the invention that the diffusion bond-inhibiting agent can be applied in simply water), but alternatively the parting agent may be applied in another liquid carrier such as an alcohol-based solvent for example, an alternatively again the parting agent maybe applied to the conductor other than in a liquid carrier, by for example as a dry powder by spraying using dry powder application techniques.

The parting agent is preferably applied to form a coating of thickness in the range 10 to 100 μm on the exterior of the conductor.

A surfactant may optionally be coated onto the conductor before the parting agent is applied, or alternately with coatings of the parting agent. A quantity of soluble polymer binder may also be coated alternately with the parting agent.

The sulphates which may be used in accordance with the invention have different solubilities and as a consequence a concentration consistent with the solubility must be selected. In relation to solubility, Na₂SO₄ is preferable over K₂SO₄ as it has a considerably higher solubility in cold water. There is a strong temperature dependence in the solubility of Na₂SO₄ with values rising up to 33° C. at which temperatures the solubility is a maximum of ˜500 g/l. For K₂SO₄ the solubility is about 120 g/l in cold water and 240 g/l in hot. Concentrations in the range 150-300 g/l are preferable for Na₂SO₄. Concentrations in the range 50 100 g/l are preferable for K₂SO₄. At higher concentrations blockage of the airbrush nozzle tends to occur. Li₂SO₄, which has a solubility of 257 g/l at 25° C. is preferably used in the concentration range 100-200 g/l.

The sulphates of Ca, K, Na and Li have melting point of approximately 1450° C., 1069° C., 884° C. and 859° C., respectively, The choice of one of these materials, or a combination of these materials, as a parting agent for metal-clad HTS tapes which require processing at higher temperatures than the exemplary silver-clad Bi-2223 tapes discussed herein will be obvious based on melting point. The general principle is that the melting point of the parting agent should lie safely above the heat treatment temperature. In relation to melting temperature, K₂SO₄ is preferable over Na₂SO₄, as it has a considerably higher melting temperature. In relation to both melting temperature and solubility a combination of K₂SO₄ and Na₂SO₄ may be preferable, such as 30% K₂SO₄ and 70% Na₂SO₄, for example.

The preferred parting agent compounds, Li₂SO₄, Na₂SO₄ and K₂SO₄, are highly soluble in water and thus comply with the said preference for aqueous solution. The slower evaporation rate of water compared with many organic solvents makes it preferable to apply heat, for example in the form of a flow of hot air, to assist evaporation.

The parting agent may be used with any inert metal-clad HTS tape and typically the cladding or metal matrix will be silver or an alloy silver. The cladding may typically be silver metal alloyed with other metals in minor part so as to, for example improve the mechanical draw-ability, or for example modify the thermal conductivity of the silver cladding.

The parting agent may be used with any HTS oxide material within the metal-clad tape and preferably where the HTS oxide material is one of the known HTS materials in the classes Bi/Sr/Ca/Cu/O, (Bi,Pb)/Sr/Ca/Cu/O, Tl/Sr/Ca/Cu/O, Tl/Ba/Ca/Cu/O, (Tl,Pb)/Sr/Ca/Cu/O or R/Ba/Cu/O where R is Y or any lanthanide rare earth element or combination thereof. Even more preferably these materials include the materials generally referred to as Bi₂Sr₂CaCu₂O_{8+δ}, (Bi,Pb)₂Sr₂CaCu₂O_{8+δ}, Bi₂Sr₂Ca₂Cu₃O_{10+δ}, (Bi,Pb)₂Sr₂Ca₂Cu₃O_{10+δ}, and RBa₂Cu₃O_{7-δ}. The value of δ usually takes on a small value typically ≦0.35. It is recognised that, in practise, these materials may have small deviations from these nominal formulae. For example, in the above materials Bi+Pb may exceed the value 2.0 and may be more typically 2.1 and there may be some cross substitution of Bi or Pb onto the Sr site. Most preferably the HTS materials applicable to the present invention include (Bi,Pb)_{2.1}Sr₂Ca₂Cu₃O_{10+δ}. This, and related materials often loosely described as (Bi,Pb)₂Sr₂Ca₂Cu3O_{10+δ}, will be referred to as Bi-2223 as is common in the art of high-temperature superconductivity. Here subscripts may be considered to be accurate to within ±0.05. As is well known in the art, for the two copper layer materials Bi₂Sr₂CaCu₂O_{8+δ}, Tl₂Sr₂CaCu₂O_{8+δ}, and (Tl,Pb)Sr₂CaCu₂O_{7+δ} the element R may be partially substituted for Ca to render HTS mater with high T_{c} values. These also will be included in the scope of the present invention.

The invention is further illustrated by the following examples.

### EXAMPLE 1

The compounds listed in Table 1 were tested for suitability as parting agents. Included in Table 1 are the melt temperature and typical cost of the test materials. The test compounds were dried at 200° C. and well ground using a mortar and pestle. A suspension or solution of each test material in isopropyl alcohol was droppered onto a small piece of Bi-2223 silver-clad tape, one for each test material. The alcohol was allowed to evaporate. This left fine layer of the compound on the surface, and in most cases the compound was well dispersed. Each piece of tape was then sandwiched together with another uncoated tape of similar length, bound with chrome thermocouple wire and processed.

Processing tests involved heating the samples to a fixed temperature between 820° C. and 840° C. in air for 16 hours, parting and cleaning with cold/hot water or dilute HCl, and inspecting as appropriate with scanning electron microscopy (SEM). Qualitative results are listed in the “comments” column in Table 1. As test comparisons, several uncoated sample pairs were run through identical heat treatments and in each case could not be parted.

CaSO₄ allowed very easy separation, but was more difficult to remove from the surface of the separated tape. Na₂SO₄ and K₂SO₄ exhibited satisfactory separation and dissolved rapidly in cold or hot water. These materials therefore could also be easily removed from the tapes and, if necessary, water could be used to assist in separation.

TABLE 1

| | Melt/dec | | |
|---|---|---|---|
| Material | ° C. | A$/kg | Comments |
| CaSO₄ | 1450 | 100 | Good parting agent but not as |
| | | | readily removed |
| K₂SO₄ | 1069 | 50 | Removed in cold water |
| Na₂SO₄ | 884 | 25 | Removed in cold water |

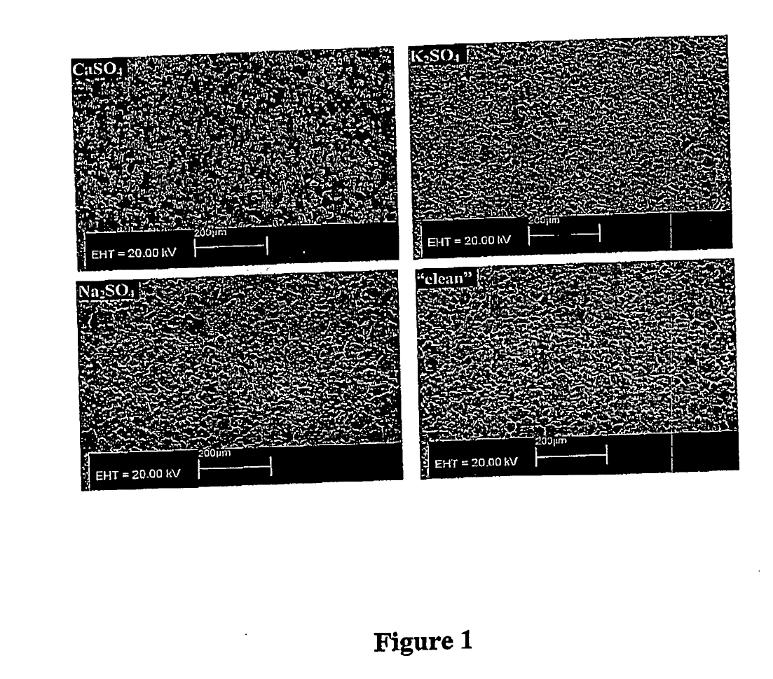

These materials were trialled on separate silver-clad HTS tapes bound to uncoated tapes and compared with an uncoated-pair sample. Several examples of all four pairs were run through a typical full multiple-step deformation/annealing cycle over 6 days as might be used in a manufacturing process. Some of the sample tapes were coated on just one side and some on both sides. Following completion of the heat treatment the samples were cleaned with hot water then inspected using SEM. The SEM micrographs shown in FIG. 1 revealed that the Na₂SO₄ and K₂SO₄ coatings were fully removed. The CaSO₄ coating was partially removed using hot water combined with ultrasonic agitation. The critical current, I_{c}, measured on the four samples in liquid nitrogen showed that the parting agents did not have a significant effect on the superconducting material. The critical currents were very similar, each in excess of 35 A.

### EXAMPLE 2

An aqueous solution of Na₂SO₄, of concentration 300 g/l was made up and sprayed using an airbrush onto the silver surface of several precursor Bi-2223 HTS tapes. Simultaneously, a hot air gun was used to rapidly evaporate the water from the sprayed solution. In this way, the parting agent material was precipitated out of solution before enough water collected to form large droplets. Several light applications were used to ensure a desirable layer thickness with an appropriate level of uniformity. Approximately one second drying time was allowed between each application.

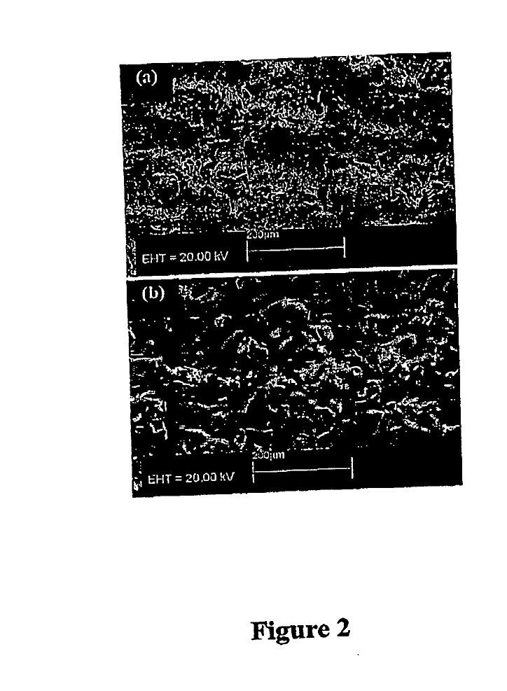

The process above was repeated using K₂SO₄ but with a lower concentration of 100 g/l because of the lower solubility. The K₂SO₄ layer was smoother, but also more fragile, than the similarly applied Na₂SO₄ layer, possibly due to slower application with more dilute solution. After annealing at ≈830° C. in air for 16 h both materials, applied in one surface only, allowed easy parting of silver tapes. Both materials appeared to sinter to themselves somewhat, Na₂SO₄ more so than K₂SO₄. This sintering, evident for Na₂SO₄ in the SEM pictures in FIG. 2, is not detrimental but actually enhances the parting properties. There does not seem to be much sintering or bonding to the silver surface, as the parting agent was not transferred to the second uncoated piece of tape to which it was bound.

### EXAMPLE 3

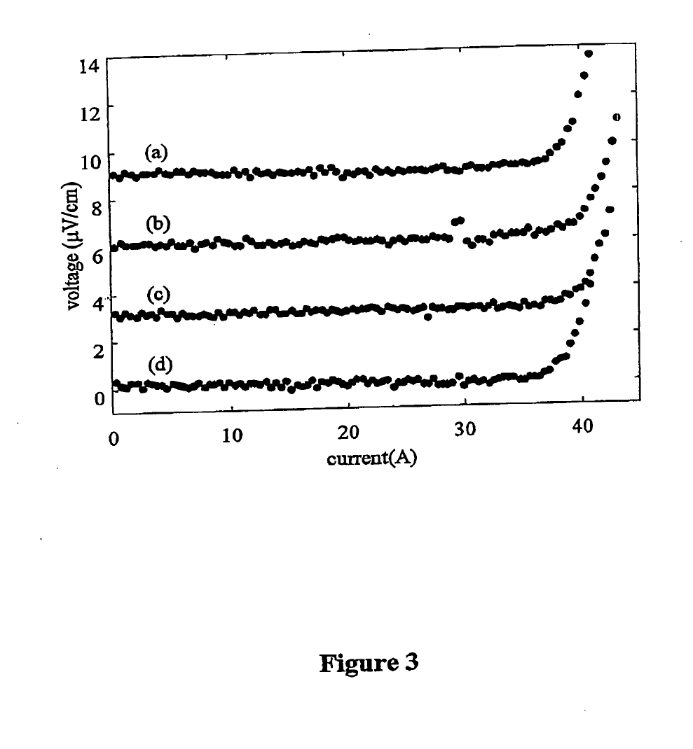

Several silver-clad Bi-2223 precursor tapes were coated with the Na₂SO₄ parting agent using the spray method of example 2. These were sandwiched in pairs, and processed through the typical full manufacturing heat treatment process. Uncoated unpaired samples were included as references. Also included were samples coated on both sides, and a stack of seven samples coated on one side and all bound together (to simulate tapes coiled on a drum). All coated samples were easily parted after treatment, and, as shown by the representative current-voltage curves in FIG. 3, critical currents were all in the range 37-40 A. There were no clear systematic trends regarding presence or absence of parting agent, or the configuration of multiple bound tapes.

### EXAMPLE 4

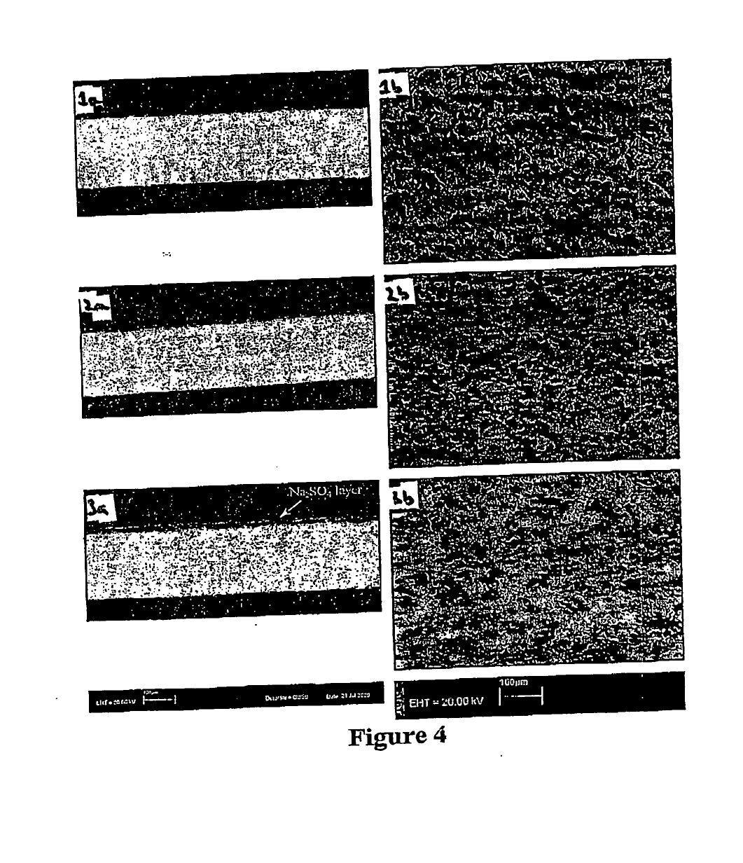

Three pairs of tapes were coated, as described in example 2, with incrementally more Na₂SO₄; one piece of each pair was retained for SEM and the other for heat processing, bound to an uncoated piece. A pair of uncoated tapes was also included. The heat treatment was again ≈830° C. in air for 16 hours. The surface and cross sections were examined by SEM to determine the coating distribution and thickness and the SEM images are shown in FIG. 4. The tapes are labeled 1 through 3 with increasing Na₂SO₄ application. The cross sectional pictures show that a fairly uniform thickness of about 20 μm was achieved for the thickest application. Following heat processing the following observations were made: the uncoated tapes could not be parted; coated pair 1 (1a and 1b) came apart cleanly when a blade was inserted between the two; and coated pairs 2 and 3 (2a and 2b; 3a and 3b) fell apart without force.

This indicates that a 20 μm layer of Na₂SO₄, applied to one mating surface only, is a sufficient parting agent for the silver/HTS tapes.

### EXAMPLE 5

A detergent solution was applied directly to a silver-clad HTS tape using a Q-tip, and rapidly dried with a hair dryer. This left a residue of the detergent on the tape. Subsequent application of Na₂SO₄ with airbrush and hair dryer produced a more uniform coating than in example 2, with even light coatings giving good coverage. Two pairs of tapes, one with detergent applied and one without, were coated simultaneously to give the same coating conditions and quantities. Applied directly onto the silver surface, SEM micrographs showed there is a clear tendency for the parting agent to agglomerate. However, the surface previously coated with detergent exhibited much more uniform coverage under the same conditions. The detergent could be applied either using the airbrush or with a Q-tip.

### EXAMPLE 6

15 cm long silver-clad Bi-2223 HTS tapes were coated with Na₂SO₄ as described in example 2. They were then subjected to repeated bending through a bend diameter of 10 cm. The coatings were then examined using SEM. This bending produced no visible damage to the parting agent layer, whether the coating was on the inside or outside of the bend. With the coating on the outside, a bend diameter of less than 3 cm could be achieved before any cracking of the coating was evident. With the coating on the inside, the coating was less stable, but still survived down to a 5 cm bend diameter.

### EXAMPLE 7

As an example of the combined use of polymer binders with the sulphate parting agent, an aqueous solution of polyvinyl pirrolidone (PVP) was applied to a silver-clad HTS tape using a Q-tip, partially dried, and followed with the Na₂SO₄ airbrush application. The resulting two-layer coating was much more robust than the single Na₂SO₄ coating, withstanding a considerable amount of direct handling and scratching, but was still removed with cold water. Careful timing of application of the PVP layer maybe important as if the PVP layer is allowed to dry completely it may not combine with the Na₂SO₄. On the other hand if the Na₂SO₄ is applied too soon, large water droplets may form and uneven coatings result.

### EXAMPLE 8

Examples 1, 2, 3 and 4 show that the parting agents Na₂SO₄ and K₂SO₄ do not significantly affect the properties of the HTS tape following heat treatment, provided that the HTS material is well encased in silver, with no significant penetration of the parting agent into or through the silver layer. Because in practise there may be occasional defects in the tape, for example pinholes or weep-holes, where the HTS material may be exposed at the surface it is essential to investigate the reactivity between Na₂SO₄ and exposed HTS material.

The superconducting oxide cores of silver-clad Bi-2223 HTS tape samples were exposed (1) by cutting a gash through the surface with a blade and (2) by chemically etching the silver with an ammonia/hydrogen-peroxide solution. The Na₂SO₄ parting agent was applied over the sample using the spray coating technique of example 2. The samples were heat treated at ≈830° C. in air for 40 hours and then, after removing the samples from the furnace, the parting agent was dissolved off the tapes by dipping in water which were then analyzed by SEM.

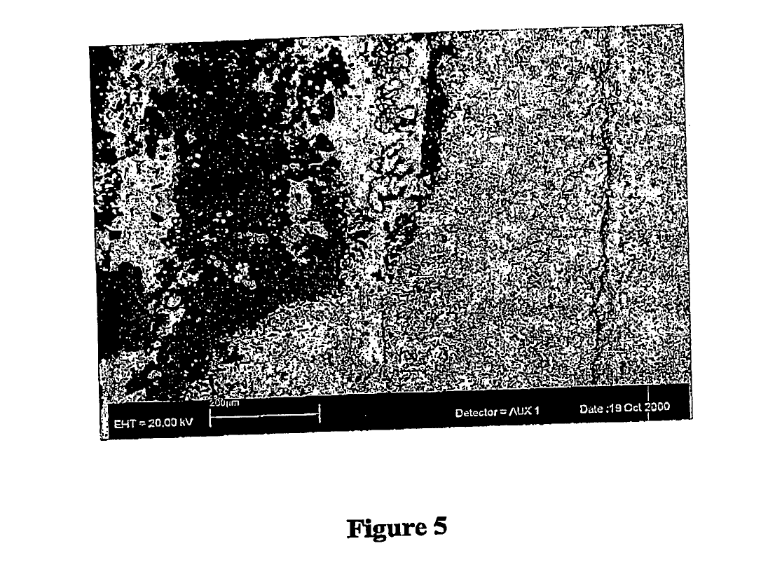

The SEM image in FIG. 5 shows a surface image of a sample that had been etched to expose the Bi oxide filaments prior to application of Na₂SO₄. It is clear that there has been some interaction, with direct contact with Na₂SO₄ preventing complete Bi-2223 formation. On the left hand side of the image the dark grains consist of copper oxide, with some pale bismuth-rich specks apparent. The right hand side of the image shows a good Bi-2223 filament that has been undisturbed by the parting agent, presumably due to less intimate contact. A reference sample that had been etched but not coated showed none of the copper oxide separation evident in this sample.

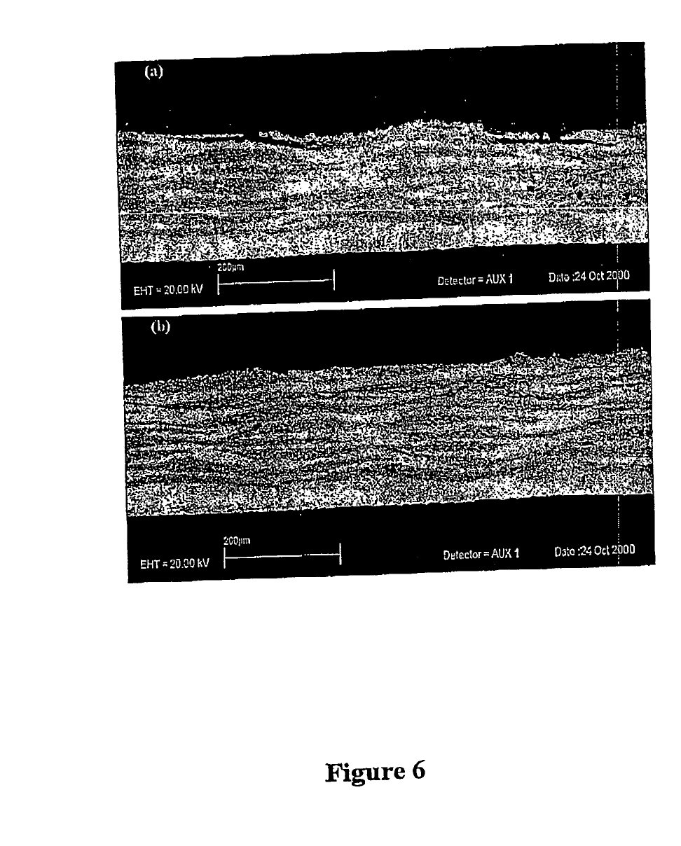

Cross-sectioned images of this same sample are shown in FIG. 6 with (a) showing a portion of the affected by reaction with Na₂SO₄ and (b) a section that was unaffected.

In FIG. 6(a) clumps of copper oxide can be seen at the etched surface, and the Bi-2223 filaments that have been partially exposed are left bismuth-rich (paler colour). However, those filaments that have not been exposed are unaffected and have the desired composition. Similar results were seen for the samples with a gash cut out by a blade, with copper oxide granules appearing at the surface leaving bismuth-rich material in the exposed filaments.

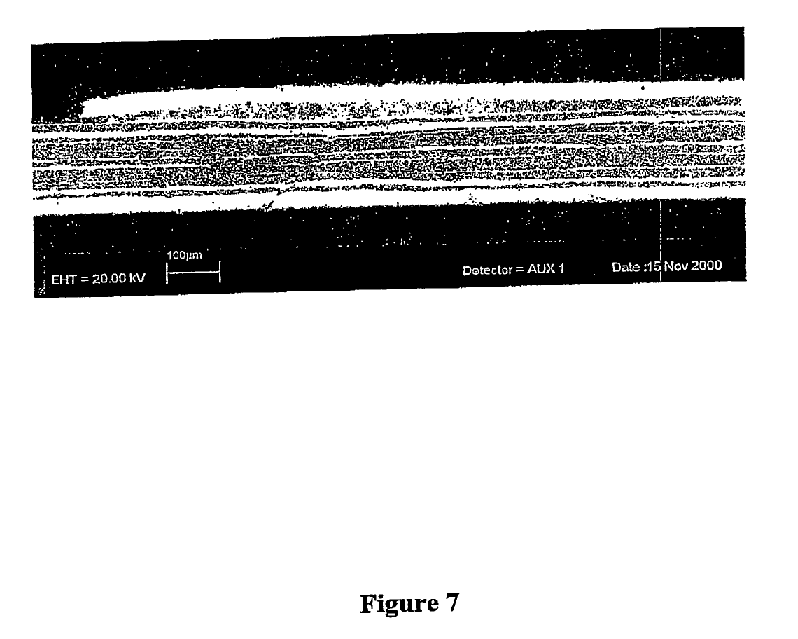

A further sample was prepared with only a small area of the silver tape surface etched away, to deter how much the exposed filament was affected beyond the defect. The sample was spray-coated with Na₂SO₄ as in example 2 and heated at ≈830° C. for 40 hours in air. A side-on cross section is shown in FIG. 7, with the etched portion of the surface at top left and Na₂SO₄ parting agent still present on the surface. The one exposed filament has a paler colour indicating copper deficiency. The damage extends to approximately 1 mm from the exposed section of the tape. Beyond this range the composition of the top filament is normal. Again, those filaments that had not been exposed have the expected and desired Bi-2223 composition.

### EXAMPLE 9

Example 8 was repeated in the same manner but using K₂SO₄ coating. This yielded similar results to example 8 with a significant degree of interaction where the coating was in immediate contact with the Bi oxide, but this reaction remained well localized to the exposed area.

### EXAMPLE 10

Reaction of Bi-2223 silver-clad HTS tapes is usually carried out in an oxygen partial pressure lower than that of air. Equilibration of the oxygen activity in the Bi oxide material is accomplished by the rapid diffusion of oxygen through the silver. The presence of a parting agent enveloping the tape may hinder this diffusion and thus modify the formation of Bi-2223.

The effect of Na₂SO₄ parting agent on the Bi-2223 formation was tested by quenching double-sided coated and uncoated samples at various intervals during a 40 hour heat treatment under typical manufacturing process conditions. The samples then had their oxide cores exposed which were examined by x-ray diffraction. The resultant x-ray diffraction patterns showed no discernible differences between coated and uncoated samples through the temporal evolution of the Bi-2223 reaction. The samples in this example did not have sealed ends.

### EXAMPLE 11

Short sections of silver-clad precursor Bi-2223 tapes were sealed at the ends as follows. A crucible of molten silver/copper alloy was maintained at about 10° C. above its melt temperature of around 930° C. The short sections of HTS tape were dipped in such a manner that only the very tip came into contact with the melt, and only for a several seconds. Though the procedure was difficult to control (with too low a temperature giving inadequate wetting of the silver onto the tape, and too high a temperature melting the tape itself) a few samples were prepared that appeared to be well sealed.

The sealed samples were investigated by differential thermal analysis, the exothermic and endothermic excursions indicating the various reaction processes in the formation of Bi-2223 in the tapes. The studies showed no difference in the reactions between the coated and uncoated sealed tapes. The only exception is the occurrence of a peak associated with the melting of Na₂SO₄ beginning at about 875° C., that is, above the usual reaction temperature for Bi-2223.

### EXAMPLE 12

A mass spectrometer was used to measure the possible evolution of SO₂ gas from Na₂SO₄ powder at elevated temperatures. A small peak at 64 a.m.u., presumed to correspond to SO₂, was discernible just above background noise for ambient air. No increase in this peak could be measured when Na₂SO₄ was introduced into the test volume and raised to temperatures up to and beyond the 875° C. melting point of Na₂SO₄. It would appear that evolution of SO₂ from the Na₂SO₄ is insignificant and does not pose an environmental hazard.

1. Method of processing an oxide superconductor or a precursor thereto contained within an outer cladding or a matrix of an inert metal to form a metal-clad HTS conductor or precursor conductor, including:
applying to the exterior of the conductor a coating comprising a diffusion bond-inhibiting agent comprising predominantly calcium sulphate, potassium sulphate, sodium sulphate, lithium sulphate, or a combination thereof, and
shaping the coated conductor so that portions thereof come into contact with one another and heat treating the conductor.

2. A method according to claim 1 including applying the diffusion bond-inhibiting agent in a liquid carrier and evaporating the carrier to leave the coating comprising the diffusion bond-inhibiting agent on the exterior of the metal-clad HTS conductor.

3. A method according to claim 2 wherein the diffusion bond-inhibiting agent comprises predominantly sodium sulphate.

4. A method according to claim 2 wherein the diffusion bond-inhibiting agent comprises predominantly potassium sulphate.

5. A method according to claim 2 wherein the diffusion bond-inhibiting agent comprises predominantly sodium sulphate or potassium sulphate or a combination thereof.

6. A method according to claim 2 wherein said carrier is an aqueous carrier.

7. A method according to claim 2 including removing at least part of the diffusion bond-inhibiting agent from the exterior of the conductor with an aqueous solvent.

8. A method according to claim 2 including applying the diffusion bond-inhibiting agent to the conductor by dipping the conductor into a liquid formulation comprising the diffusion bond-inhibiting agent.

9. A method according to claim 2 including applying the diffusion bond-inhibiting agent to the conductor by spraying a formulation comprising the diffusion bond-inhibiting agent onto the conductor.

10. A method according to claim 2 including assisting evaporating of the liquid carrier by heating the conductor.

11. A method according to claim 10 including assisting evaporating of the liquid carrier by exposing the conductor to a flow of hot air.

12. A method according to claim 2 including applying a surfactant to the conductor before applying the diffusion bond-inhibiting agent to the conductor or between multiple applications of the diffusion bond-inhibiting agent to the conductor.

13. A method according to claim 2 including applying a polymer binder to the conductor before applying the diffusion bond-inhibiting agent to the conductor.

14. A method according to claim 13 including applying the diffusion bond-inhibiting agent to the conductor after applying the polymer binder to the conductor.

15. A method according to claim 1 wherein the conductor is a tape and including applying the diffusion bond-inhibiting agent to one side only of the tape conductor.

16. A method according to claim 1 including forming on the conductor a coating of the diffusion bond-inhibiting agent having a thickness in the range 10 to 100 μm.

17. A method according to claim 1 including shaping the conductor by coiling the conductor.

18. A method according to claim 17 including coiling the conductor by winding the conductor onto a spool.

19. A method according to claim 1 wherein said inert metal forming the outer cladding or matrix is silver or an alloy of silver.

20. A method of processing an oxide superconductor or a precursor thereto contained within an outer cladding or a matrix of an inert metal to form a metal-clad HTS conductor or precursor conductor, including:
applying a diffusion bond-inhibiting agent selected from calcium sulphate, potassium sulphate, sodium sulphate, lithium sulphate, or a combination thereof, to the exterior of the conductor,
winding the coated conductor on to a spool,
heat processing the coiled coated conductor, and
unwinding the conductor and washing the conductor with an aqueous solvent to remove the diffusion bond-inhibiting agent from the exterior of the conductor.

21. A method according to claim 20 wherein the diffusion bond-inhibiting agent is sodium sulphate or potassium sulphate.

22. An HTS conductor or precursor conductor comprising an oxide superconductor or a precursor thereto contained within an outer cladding or a matrix of an inert metal and having an amount of a coating on at least a part of the exterior of the conductor comprising predominantly calcium sulphate, potassium sulphate, sodium sulphate, or lithium sulphate, or a combination thereof, which is effective to enable winding, heat processing, and unwinding of the conductor substantially without diffusion-bonding together of wound coils of the conductor during the heat processing.

23. A method of processing an oxide superconductor or a precursor thereto contained within an outer cladding or a matrix of an inert metal to form a metal-clad HTS conductor or precursor conductor, including the steps of applying to the exterior of the conductor a diffusion bond-inhibiting agent comprising calcium sulphate, potassium sulphate, sodium sulphate, lithium sulphate, or a combination thereof.

24. A method of processing an oxide superconductor or a precursor thereto contained within an outer cladding or a matrix of an inert metal to form a metal-clad HTS conductor or precursor conductor, including:
applying a formulation to the exterior of the conductor including a diffusion bond-inhibiting agent comprising predominantly calcium sulphate, potassium sulphate, sodium sulphate, lithium sulphate, or a combination thereof, and a carrier,
evaporating the carrier to leave a coating of the diffusion bond-inhibiting agent on the exterior of the metal-clad HTS conductor, and
shaping the coated conductor so that portions thereof come into contact with one another and heat treating the conductor.
